(19) United States
(12) Patent Application Publication
(10) Pub. No.: US 2026/0093106 A1
(43) Pub. Date: Apr. 2, 2026

(54) METHOD FOR EVALUATING MICROSCOPE IMAGES ILLUMINATED IN A STRUCTURED MANNER AND MICROSCOPE HAVING STRUCTURED ILLUMINATION

(71) Applicant: Carl Zeiss Microscopy GmbH, Jena (DE)

(72) Inventor: Lutz SCHÄFER, Kitchener (CA)

(21) Appl. No.: 19/345,736

(22) Filed: Sep. 30, 2025

(30) Foreign Application Priority Data
Sep. 30, 2024 (DE) 102024003249.5

(51) Int. Cl. G02B 21/36; G02B 21/14; G06T 5/70

(52) U.S. Cl. CPC G02B 21/367; G02B 21/14; G06T 5/70; G06T 2207/10016; G06T 2207/10056; G06T 2207/20221

(57) ABSTRACT

Microscopy methods and devices that use structured illumination are described. An example method includes providing multiple digital raw images of a sample that are recorded sequentially a microscope and obtained by illuminating the sample in different phases with periodically structured illumination light. The method includes, determining, using a structured illumination microscopy (SIM) reconstruction method, an intermediate imaging result for the sample with an increased resolution compared to the raw images, where the resolution is higher than the diffraction-limited resolving power of the microscope. In addition, the above method reduces or suppressed image artifacts.

### CROSS-REFERENCE TO RELATED APPLICATION(S)

This application claims priority to German Application No. 102024003249.5 titled “Method for evaluating microscope images illuminated in a structured manner and microscope having structured illumination,” filed on Sep. 30, 2024. The entire contents of the above noted patent application are incorporated by reference as part of the disclosure of this document.

### TECHNICAL FIELD

This patent document relates to microscopy methods and devices, and in particular to microscopy methods and devices that use structured illumination.

### BRIEF DESCRIPTION OF THE DRAWINGS

FIG. 1 shows a multimodal microscope.

FIG. 2 shows the known principle of structured illumination in multiple phases.

FIG. 3 shows a flowchart for improved evaluation of raw images subjected to structured illumination in accordance with an example embodiment.

FIGS. 4A-4D show example images with and without the weighting according to some example embodiments.

### DETAILED DESCRIPTION

The disclosed embodiments relate to a method for evaluating microscope images of a sample. One example method comprises the following steps: providing multiple digital raw images of the sample that were recorded sequentially by means of a microscope by illuminating the sample in different phases with periodically structured illumination light and ascertaining, by means of a structured illumination microscopy (SIM) reconstruction method, an intermediate imaging result for the sample with (in comparison with raw images) an increased resolution (in particular a resolution that is finer than the diffraction-limited resolving power of the microscope) using the raw images. The disclosed embodiments also relates to a correspondingly configured microscope having structured illumination.

On account of the diffraction of light received from the sample in the microscope objective, the resolving power of known microscopes is dependent on the aperture thereof and on the wavelength of the light. Since the usable wavelength range of the visible light is finite, the resolving power of a microscope is limited as a matter of principle (Abbe 1873). In relation to the spatial frequencies of the sample that should be imaged, this means that the support of the optical transfer function (OTF) of the microscope in the spatial frequency domain is limited to a finite region around the coordinate origin. Consequently, the microscope can image only those spatial frequencies that lie in the interval in which the support does not vanish. The OTF is the point spread function (PSF) of the microscope that has been transformed into a spatial frequency domain. The PSF indicates how a point light source is imaged by the microscope.

As a result of a structured illumination of the sample in multiple different phase angles with a subsequent calculated combination of the raw images recorded from the same sample plane (focal plane) phase-by-phase (known as “structured illumination microscopy—SIM”), it is possible to laterally (transversely to the optical axis for detection) improve the resolving power by a factor of up to two should the excitation intensity of the illumination and the emission intensity of the sample be linearly related. SIM is disclosed for example in DE application 199 08 883 A1 and in the article “Surpassing the lateral resolution limit by a factor of two using structured illumination microscopy” by M. Gustafsson (Journal of Microscopy, volume 198, 2000, p. 82). It is based on the generation of a periodic light structure on the sample to be examined, for example by sinusoidal interference of the illumination light downstream of an optical grating. On account of the convolution of the sample response with the PSF of the microscope in the spatial domain, a region of spatial frequencies of the sample structure that lie outside the support of the OTF in the spatial frequency domain is shifted into the central support interval, where said spatial frequencies are superimposed on the original spatial frequency intensities such that Moiré effects are seen in the raw images. The Fourier transform of each raw image in this context contains multiple frequency-shifted “copies” of the spatial frequency spectrum of the sample in a respective frequency band. Each of these copies is referred to as a separate “order.” Their number depends on the number of the mutually interfering beams from which the periodic light structure is generated.

According to the SIM method, it is possible to reconstruct, from a set of such raw images that contain the superpositions of the shifted and the original spatial frequencies, an intermediate imaging result with an increased resolution that contains both the original spatial frequencies of the support interval and the original higher spatial frequencies that have in the meantime been shifted into the support interval by the structured illumination. Consequently, the intermediate imaging result has a higher lateral resolution than a conventional single recording with uniform illumination. This resolution is referred to as super-resolution when it is finer than the diffraction-limited resolution of the microscope.

Various methods are known for reconstruction, for example a Wiener deconvolution or iterative methods such as the joint deconvolution, also referred to as jSIM (for example published by Chakrova et al.: “Deconvolution methods for structured illumination microscopy” in Journal of the Optical Society of America A, volume 33, no. 7, 2016, p. B12), in particular by means of the Richardson-Lucy method. The particular advantage of the iterative joint methods is that constraints such as non-negativity can be applied, whereby the amplification of background noise is reduced, and this allows for higher image contrast at least within the focal plane.

In addition to improving the lateral resolving power, SIM can also be used to generate an optical section through the sample transversely to the optical axis of detection of a focal plane (known as OS-SIM, published by Neil et al.: “Method of obtaining optical sectioning by using structured light in a conventional microscope” in Optics Letters, vol. 22, no. 24, 1997, p. 1905) from a set of raw images. For example, the resultant cross-sectional image a quasi-confocal image, and the axial resolving power also approximately corresponds to that of a confocal microscope. Should a respective set of images with structured illumination be recorded for a number N of focal planes, a z-stack of quasi-confocal cross-sectional images can be reconstructed therefrom.

The SIM can also attain axial super resolution (known as 3D-SIM). To this end, the illumination in the sample must also be periodically structured axially, and a separate set of raw images is recorded from the relevant plane for each of N sample planes. From a system of equations that describes the interactions in all N sample planes, it is possible to calculate a z-stack from N axially super-resolved, in particular also laterally super-resolved, intermediate imaging results. 3D-SIM is described in Gustafsson et al.: “Three-Dimensional Resolution Doubling in Wide-Field Fluorescence Microscopy by Structured Illumination”, Biophys. J., vol. 94, 2008, p. 4957).

It is known that the reconstruction methods, in particular jSIM reconstruction methods, generate not only the reconstruction of the modulated contributions but also unmodulated contributions, so-called “wide-field contributions”. These artifacts reduce the contrast of the SIM intermediate imaging result. Wide-field contributions mainly originate as background fluorescence from sample regions outside the focal plane of the raw images. This is particularly true for thick samples.

US Patent Publication No. 2022/092752 A1 has disclosed that order-selective filtering by means of bandpass filtering allows a suppression of unwanted spatial frequency ranges, in particular those of the wide-field contributions, such that these are reduced. Despite filtering, wide-field contributions might be retained, especially in the axial direction. They may interfere in the case of quantitative measurements in particular.

A problem addressed by the disclosed embodiments relates to improving a method and a microscope of the type set forth at the outset such that artifacts, in particular wide-field contributions from outside the focal plane, are better suppressed.

The problem is solved by the disclosed embodiments, including a method having the features specified in claim 1 and by a microscope having the features specified in claim 10.

Some advantageous configurations of the disclosed embodiments are specified in the dependent claims.

Within the context of this patent document, the term raw image does not mean that the images need be unmanipulated. Instead, raw images may be explicitly processed prior to the evaluation according to the disclosed embodiments, for example by deconvolution and/or filtering and/or alignment.

For example, the raw images gᵢ (the index i denotes the M different illumination phases 1, . . . , M) can be modeled as follows (according to Schäfer et al.: “Structured illumination microscopy: artefact analysis and reduction utilizing a parameter optimization approach” in Journal of Microscopy, volume 216, no. 2, p. 165):

$${g}_{i} = Q ( {h}_{det} * ( f \cdot ( {h}_{ill} * {s}_{i} ) ) ) = Q ( {g}_{w} + {g}_{c} cos {φ}_{i} + {g}_{s} sin {φ}_{i} ) ,$$

where h_{det}, hᵢₗₗ denotes the illumination or detection PSF, f denotes the sample, sᵢ denotes the illumination grating and Q denotes a noise function, while g_{w} are wide-field contributions and g_{c}, gₛ are oscillating contributions, and (*) is the convolution operator and φᵢ are the phase angles under which the images gᵢ were captured.

Before being provided by means of the microscope, the raw images may be recorded sequentially by illuminating the sample in different phases with periodically structured illumination light. This may be coherent or incoherent illumination, i.e. the light structure in the sample may be generated by imaging a light pattern or by interference of multiple beams.

In principle, an intermediate imaging result fᵣ can be ascertained using any desired SIM reconstruction method. However, weighting according to the disclosed embodiments is particularly advantageous should a joint reconstruction method, in particular an iterative joint reconstruction method, more particularly a method with order-selective filtering, be used for ascertaining the intermediate imaging result. The achievable suppression is particularly strong in these methods. For example, an iterative joint reconstruction may be carried out using a modified Richardson-Lucy method according to Chakrova et al. (see above):

$${f}_{r , k + 1} = {f}_{r , k} {\sum }_{i = 1}^{M} {\hat{s}}_{i} [ \frac{{g}_{i}}{( {f}_{k} \cdot {\hat{s}}_{i} ) * {h}_{det}} ] * {h}_{det}^{T} ,$$

where f_{r,k} denotes a reconstructed intermediate imaging result after k iterations, ŝᵢ=hᵢₗₗ*sᵢ denotes the imaging of the illumination grating into the sample and

$${h}_{det}^{T}$$

denotes the adjoint detection PSF. All variables found in the above equations are vectors or operators in the 3D- [symbol] -domain.

According to the disclosed embodiments, provision is made for elements (2D pixels or 3D voxels represented by vectors) of the intermediate imaging result to be weighted and for the intermediate imaging result weighted thus to be output as imaging result with the weighted elements. All elements of the intermediate imaging result may be weighted, but a subset thereof is sufficient. Weighting may be carried out in particular by way of a respective multiplication for the elements in question.

Weighting allows the effective reduction or suppression of artifacts.

Prior to weighting, the intermediate imaging result may be processed, for example by deconvolving and/or filtering.

Advantageously, a cross-sectional image of the sample (without wide-field contributions in particular) is ascertained on the basis of the raw images by means of a reconstruction method (in particular by means of OS-SIM or a corresponding method or a method derived therefrom) prior to weighting, and the weighting is performed on the basis of elements (2D pixels or 3D voxels represented by vectors) of the cross-sectional image. In particular, one of the elements of the intermediate imaging result may be weighted on the basis of at least one of the elements of the cross-sectional image in this case. This type of weighting leads to a significant suppression of artifacts, especially of out-of-focus wide-field contributions, by enhancing the optical sectioning effect. Usually, weighting is performed for each element in the intermediate imaging result. For example, the cross-sectional image fₒₛ can be ascertained according to Schäfer et al. (see above) after the components g_{c} and gₛ have been separated:

$${f}_{os} = \sqrt{{g}_{c}^{2} + {g}_{s}^{2}}$$

Such a cross-sectional image (and also cross-sectional images ascertained according to the method described by Neil et al.; see above) has no zeroth-order contributions and hence no wide-field contributions either. These cross-sectional images are therefore particularly suitable for weighting (and removing wide-field contributions).

Preferably, to this end, weighting one of the elements in the intermediate imaging result involves multiplying the element in question by an element of the cross-sectional image fₒₛ. This allows weighting with little computational outlay. Typically, each element in the intermediate imaging result is multiplied by the element of the cross-sectional image that matches its position in the sample (point-by-point, i.e. pixel-by-pixel or voxel-by-voxel multiplication).

In a preferred embodiment, weighting one of the elements in the intermediate imaging result fᵣ involves multiplying the element in question by a factor that depends on elements of the raw images and/or elements of the intermediate imaging result and/or elements of the cross-sectional image. In that case, the imaging result \tilde{f} for example emerges according to:

$$\tilde{f} = ℳ \cdot {f}_{r} \cdot {f}_{os}$$

This multiplication may be considered to be a normalization to keep the value range of the elements in the imaging result within a predetermined range. However, [symbol] =1 could also be used.

In particular, the factor may contain the mean values of the raw images in the following form:

$$ℳ = \frac{1}{M \cdot N} \frac{{\sum }_{i}^{M} {\sum }_{n}^{N} {g}_{i , n}}{〈 {f}_{os} , {f}_{r} 〉} ,$$

where M is the number of illumination phases, N is the number of pixels or voxels in an image and < > is a scalar product operator.

In some embodiments, the factor depends exclusively on elements of the raw images. The advantage thereof is that the factor may already be ascertained before the reconstruction method(s). In particular, the factor may correspond to the inverse of a mean value of the raw images:

$$ℳ = \frac{M \cdot N}{{\sum }_{i}^{M} {\sum }_{n}^{N} {g}_{i , n}}$$

Alternatively, it may correspond to the mean value of the raw images:

$$ℳ = \frac{{\sum }_{i}^{M} {\sum }_{n}^{N} {g}_{i , n}}{M \cdot N}$$

Alternatively, the factor may depend exclusively on elements of the intermediate imaging result. In particular, the factor may be the inverse of the sum of all elements, or at least of some elements, of the intermediate imaging result:

$$ℳ = \frac{1}{\sum {f}_{r}}$$

Alternatively, the factor may depend exclusively on elements of the intermediate imaging result and on elements of the cross-sectional image:

$$ℳ = \frac{\sum {f}_{r}}{〈 {f}_{os} , {f}_{r} 〉}$$

This advantageously retains the overall intensity of the intermediate imaging result. Weighting redistributes the intensity.

The example embodiments also comprise a microscope having a control unit configured to perform the above-described methods and being equipped with a light source, a two-dimensionally spatially resolving detector for recording raw images of the sample and means for generating periodically structured illumination light, in particular sinusoidally structured illumination light, in the sample in different phases, wherein in particular no stop that optically sections the sample is arranged in front of the detector. The invention also comprises a computer program and a control unit, each configured to perform one of the above-described methods.

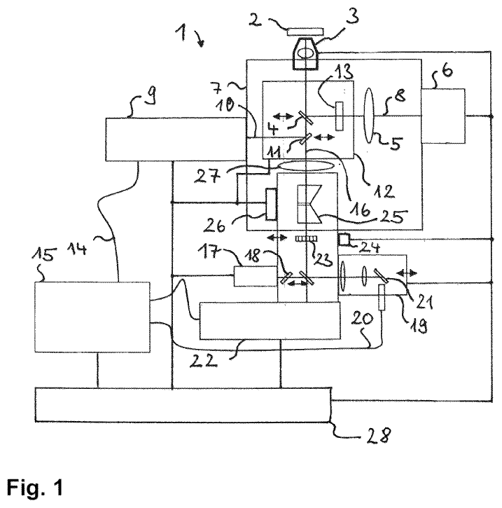

FIG. 1 shows a microscope 1 that has different operating modes. Said microscope is capable of performing both conventional microscopy methods, i.e. microscopy methods with a diffraction-limited resolution, and super-resolution microscopy methods, i.e. microscopy methods whose resolution goes beyond the diffraction limit. This is an inverted microscope. Alternatively (not shown here), it may be embodied in the form of an upright microscope.

The microscope 1 captures a sample 2. To this end, it comprises an objective 3 that is traversed by the radiation for all microscopy methods described below.

Via a beam splitter 4 and in conjunction with a tube lens 5, the objective 3 images the sample onto a two-dimensionally spatially resolving area detector 6, which is a CCD detector in the present example but could also be configured as a CMOS detector, for example. In this respect, the microscope 1 has a conventional light microscope module 7, and the beam path from the sample 2 through the objective 3 and the tube lens 5 to the CCD detector 6 corresponds to a conventional wide-field detection beam path 8. As indicated by the double-headed arrow in FIG. 1, the beam splitter 4 is interchangeable so that it is possible to switch between beam splitters with different dichroic properties or achromatic beam splitters, as described in, for example, U.S. Patent Publication No. 2008/0088920.

Also incorporated in the beam path to the objective 3 is a laser scanning module 9, the LSM illumination and detection beam path of which is input coupled into the beam path to the objective 3 via a switching mirror 11 that also possesses beam splitter functions. The beam path from the switching mirror 11 to the objective 3 through the beam splitter 4 is thus a beam path in which the illumination beam path and the detection beam path are combined. This is true both with respect to the laser scanning module 9 and with respect to the wide-field detection beam path 8, because, as yet to be explained below, illumination radiation which together with the wide-field detection beam path 8, i.e. the CCD detector 6, realizes microscopy methods is also input coupled at the switching mirror 11.

The switching mirror 11 and the beam splitter 4 are combined to form a beam splitter module 12, as a result of which there is the possibility of interchanging the switching mirror 11 and the beam splitter 4 depending on the application. This is also illustrated by double-headed arrows. Also provided in the beam splitter module 12 is an emission filter 13 that is located in the wide-field detection beam path 8 and suitably filters the spectral components that can propagate through the wide-field detection beam path 8. Naturally, the emission filter 13 in the beam splitter module 12 is also interchangeable.

The laser scanning module 9 receives laser radiation required for the operation from a laser module 15 via an optical fiber 14.

In the construction illustrated in FIG. 1, a collective illumination beam path 16 that is traversed by illumination radiation for various microscopy methods is input coupled at the beam splitter module 12, more specifically at the switching mirror 14. Different illumination beam paths of individual illumination modules are input coupled into this collective illumination beam path 16. For example, a wide-field illumination module 17 couples wide-field illumination radiation into the collective illumination beam path 16 via a switching mirror 18 such that the sample 2 is subjected to wide-field illumination via a tube lens 27 and the objective 3. The wide-field illumination module 17 may comprise an HBO lamp, for example. Provided as a further illumination module is a Total Internal Reflection Fluorescence (TIRF) illumination module 19, which realizes TIRF illumination in the event of appropriate positioning of the switching mirror 18. To this end, the TIRF illumination module 19 receives radiation from the laser module 15 via an optical fiber 20. The TIRF illumination module 19 has a longitudinally displaceable mirror 21. On account of the longitudinal displacement, the illumination beam emitted by the TIRF illumination module 19 is displaced perpendicularly to the main propagation direction of the emitted illumination beam, as a result of which the TIRF illumination is incident on the objective 3 at an adjustable angle with respect to the optical axis of the objective. In this way, the required angle of total-internal reflection at the coverslip can be readily ensured. Naturally, other means are also suitable for effecting this angle adjustment.

Also coupled to the collective illumination beam path is the illumination beam path of a manipulator module 22 that also receives radiation from the laser module 15 via an optical fiber (not designated further here) and guides a punctiform or linear beam distribution over the sample 2 in a scanning fashion. The manipulator module 22 thus substantially corresponds to the illumination module of a laser scanning microscope, and, as a consequence, the manipulator module 22 may also be operated in a manner combined with the detector of the laser scanning module 9 or the wide-field detection of the CCD detector 6.

Also provided in the collective illumination beam path 16 is a grating 23 whose grating constant for example is below the cut-off frequency that can be transferred with the microscope 1 into the sample 2. The grating 23 can be arranged for example in a plane (intermediate image of the sample) of the illumination beam path 16 that is imaged into the sample. For example, this may be a Ronchi grating. The grating 23 is displaceable transversely to the optical axis of the collective illumination beam path 16 in preferably two dimensions transversely to the optical axis. To this end, a corresponding displacement drive 24 is provided.

An image field rotator 25, which is rotated by a rotator drive 26, is furthermore arranged in the collective illumination beam path 16 downstream of the grating in the illumination direction. The image field rotator can be an Abbe-Koenig prism, for example. Should the grating 23 be two-dimensionally structured, the image field rotator 25 may be omitted because the resultant illumination structure requires no rotation. Instead, it may be displaced in two dimensions, for example.

The microscope 1 comprises a control unit 28, for example a computer in Von-Neumann architecture, which has in particular a processor as a calculation and control unit, a random-access memory as the working memory, and a magnetic hard disk as a mass storage means.

The modules and drives and also detectors of the microscope 1 are all connected to the control unit 28 via lines (not designated further here). For example, the connection can be realized by way of a data and control bus. The control unit 28 controls the microscope 1 in different operating modes. The control device 28 thus allows conventional microscopy to be carried out using the microscope 1, i.e. wide-field microscopy (WF), in particular with structured illumination (SIM), laser scanning microscopy (LSM), and also fluorescence microscopy with total-internal reflection (TIRF).

The microscope in FIG. 1 comprises substantially two modules that are suitable for laser scanner illumination, specifically the laser scanning module 9 and the manipulator module 22. Naturally, other combinations are also possible. Said modules are coupled onto the sample 2 via tube lenses with the objective 3. The manipulator module 22 only contains the excitation part of a laser scanning module, without detection. As a result, the sample can be subjected to punctiform illumination, and the illumination spot can be raster-scanned over the sample 2.

Preferably, the manipulator module 22 also contains a switching unit, for example a switching lens or cylindrical lens, which brings about switching between punctiform and linear illumination. Said linear illumination is advantageous in particular when the grating 23 is pivoted in and located perpendicularly to the line of the linear illumination. Alternatively, the linear illumination could be used for the dynamic (sequential) generation of structured illumination in the sample 2.

In other embodiments (not shown here), a variably adjustable strip modulator or a Digital Micromirror Device (DMD) or a Spatial Light Modulator (SLM) or an optical waveguide that ends in a pupil plane may be used as an alternative to the grating 23 in order to generate structured illumination in the sample 2. In that case, the displacement drive 24 and the ability to pivot the grating 23 in and out are no longer required. In particular, the illumination therewith can be implemented in such a way that the light structure is generated in the sample by the interference of multiple beams such that its period is close to the cut-off frequency of the microscope. Alternatively, this is possible if the grating 23 is configured as a diffraction grating.

The image field rotator 25 allows the structured illumination generated by way of the grating 23 (or by the elements replacing the latter) to be rotated about the optical axis of the collective illumination beam path 16 such that the structured illumination lies at different angles in the sample 2.

To switch between individual operating types, the switching mirrors 18 and 11 and the beam splitter 4 are set appropriately. In the realization, folding or pivot mirrors can be used to this end, such that switching between the operating types can be effected sequentially. Alternatively, dichroic mirrors that allow simultaneous operation of the various modules are also possible.

The beam splitter 4 preferably takes the form of a dichroic beam splitter, wherein the spectral properties can be set such that spectral components of fluorescence emission from labeling molecules that should be detected with the aid of the CCD detector 6 pass into the wide-field detection beam path 8, and the remaining spectral components are transmitted where possible. To increase the flexibility as regards the usability of labeling molecules with different emission characteristics, multiple different beam splitters 4 and emission filters 13 are arranged in the beam splitter module 12 in a manner such that they are interchangeable, for example on a filter wheel.

The above-described microscope can serve to generate a super-resolved intermediate imaging result. To this end, the control device 28 is suitably designed, for example by way of suitable programming for reconstructing the intermediate imaging result from multiple raw images with structured illumination in different illumination phases. The control device 28 is also configured to ascertain a cross-sectional image from the raw images, to use the cross-sectional image to weight the intermediate imaging result and to output the latter as an imaging result.

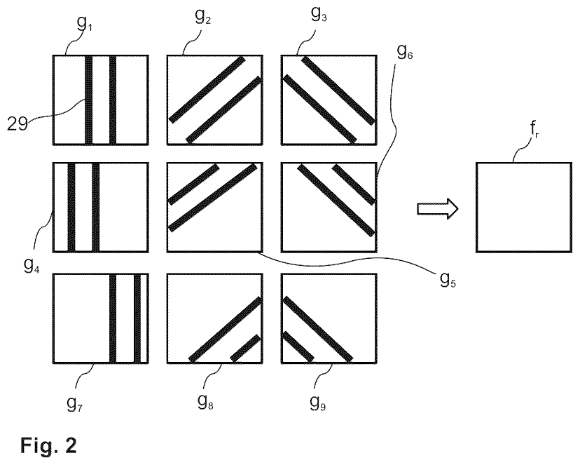

FIG. 2 schematically illustrates the for generating a super-resolved image in an individual sample plane according to the SIM method. The sample examined under the microscope 1 of FIG. 1 is repeatedly imaged using a wide-field technique, with different illumination states being set.

FIG. 2 shows a set of raw images gᵢ that all represent the same sample region and are from a single sample plane but differ in terms of a light structure 29 that is transferred during the recording of the raw images gᵢ into the sample 2 by way of structured illumination by means of the illumination beam path 16. It is evident that for example lateral, periodic light structure 29 is oriented and positioned differently in the different raw images gᵢ but has an identical period in all the raw images gᵢ. By way of example, nine raw images gᵢ (from nine different illumination and image recording phases) are present and made up of three different orientations of the structure 29 and three different displacement positions of the structure 29. The various orientations and displacement positions are grouped together under the term phases. Naturally, different numbers of different phases are also possible, especially also greater numbers, as known from the publications cited above relating to the principle of SIM. In an alternative embodiment, it is possible to perform only those illumination and image recording phases in which the light structure 29 has the same orientation in each of the phases (i.e. only occupies different displacement positions) and/or only use these phases in a reconstruction method, for example only generate the raw images g₁, g₄ and g₇ (or only use these in the reconstruction).

However, the structure 29 shown is to be understood to be purely by the way of example. In particular, there is no need for it to be a line structure. It is also possible for the schematically drawn lines to be structured further along the lines. Rather than using the line-type structuring used in the initially cited SIM publications, it is equally possible to use scanned confocal point or line illumination with confocal detection, as is known from the publication “Image scanning microscopy” by C. Müller and J. Enderlein, Physical Review Letters, 104, 198101 (2010). This principle is referred to as ISM. Naturally, there are not nine orientations of structured illumination available in that case, but a suitable multiplicity of raw images obtained from scanning a sample 2. Each raw image gᵢ then corresponds to a specific scanning location, i.e. a specific raster-scanning state during the raster-scanning of the image.

From the recorded raw images gᵢ, the control unit 28 calculates a super-resolved intermediate imaging result fᵣ, for example by means of an iterative joint SIM reconstruction method including order-selective filtering.

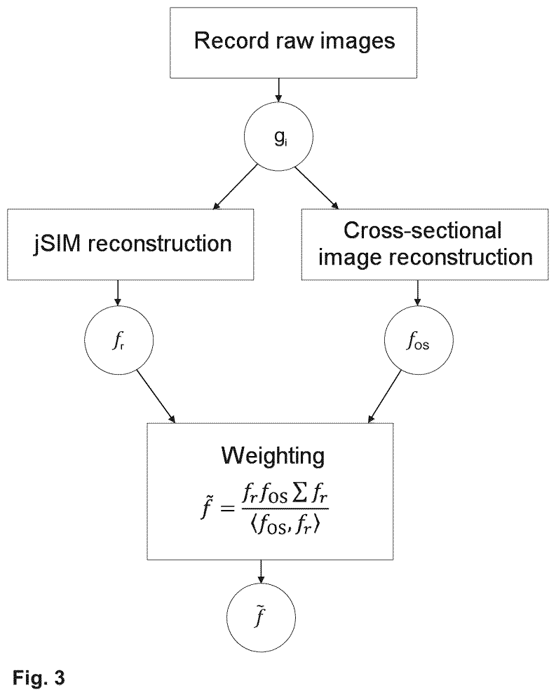

FIG. 3 shows an exemplary sequence of how the control unit 28 ascertains a cross-sectional image fₒₛ from the raw images gᵢ in addition to the intermediate imaging result fᵣ and weights the intermediate imaging result fᵣ point-by-point using the cross-sectional image fₒₛ multiplied by the selected normalization factor [symbol] .

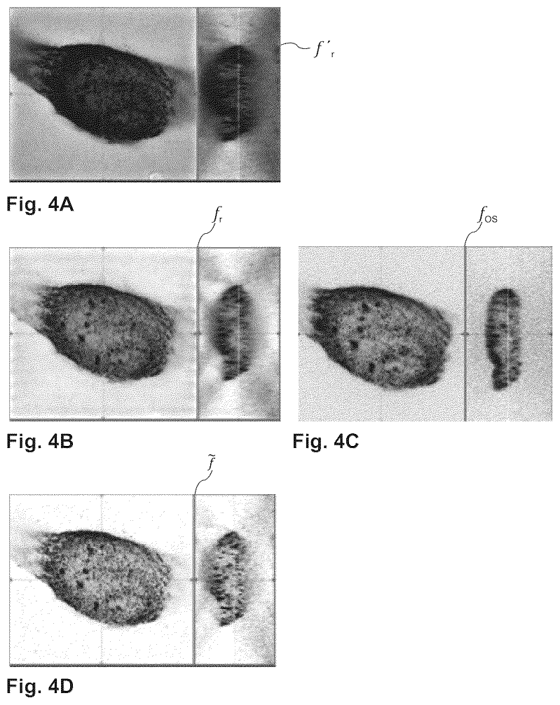

Finally, FIG. 4 shows example images, in each case in axial view (i.e. transverse section through the sample) in the left panel and in lateral view (i.e. in axial section through the sample) in the right panel of each image.

Initially, FIG. 4A shows an intermediate imaging result fᵣ′ ascertained by means of iterative joint SIM reconstruction without order-selective filtering, and FIG. 4B shows a further intermediate imaging result fᵣ ascertained by means of iterative joint SIM reconstruction with order-selective filtering. The suppression of out-of-focus light by the order-selective filtering is clearly visible in FIG. 4B. Nevertheless, artifacts are still visible in the axial section. FIG. 4C represents the cross-sectional image fₒₛ ascertained from the same raw images. In FIG. 4D, the imaging result f is shown in the form of the intermediate imaging result

$${f}_{r}^{′}$$

weighted on the basis of the cross-sectional image fₒₛ. For example, the weighting is implemented according to:

$$\tilde{f} = \frac{\sum {f}_{r}}{〈 {f}_{os} , {f}_{r} 〉} \cdot {f}_{r} \cdot {f}_{os}$$

In this case, the overall intensity is retained:

$$\sum \tilde{f} ≡ \sum {f}_{r}$$

In an alternative embodiment (not shown), the imaging result may be ascertained from an intermediate imaging result

$${f}_{r}^{′}$$

ascertained like FIG. 44 without order-selective filtering:

$$\tilde{f} = \frac{\sum {f}_{r}^{′}}{〈 {f}_{os} , {f}_{r}^{′} 〉} \cdot {f}_{r}^{′} \cdot {f}_{os}$$

In this case, too, the overall intensity is retained.

From the foregoing, it will be appreciated that specific embodiments of the invention have been described herein for purposes of illustration, but that various modifications may be made without deviating from the scope of the invention. Accordingly, the invention is not limited except as by the appended claims.

### LIST OF REFERENCE SIGNS

1 Microscope
2 Sample
3 Objective
4 Beam splitter
5 Tube lens
6 CCD detector
7 Light microscope module
8 Wide-field detection beam path
9 Laser scanning module
11 Switching mirror
12 Beam splitter module
13 Emission filter
14 Optical fiber
15 Laser module
16 Collective illumination beam path
17 Wide-field illumination module
18 Switching mirror 18
19 TIRF illumination module
20 Optical fiber
21 Mirror
22 Manipulator module
23 Lattice
24 Displacement drive
25 Image field rotator
26 Rotator drive
27 Tube lens
28 Control device
29 Illumination structure
gᵢ Intermediate imaging result
fᵣ Intermediate imaging result
fₒₛ Cross-sectional image
\tilde{f} Imaging result

I/We claim:

1. A method for evaluating microscope images of a sample, comprising the following steps:
providing multiple digital raw images (gᵢ) of the sample recorded sequentially by a microscope by illuminating the sample in different phases with periodically structured illumination light;
determining, using a reconstruction method, an intermediate imaging result (fᵣ) for the sample with an increased resolution using the raw images (gᵢ);
weighting elements of the intermediate imaging result (fᵣ); and
outputting the intermediate imaging result (fᵣ) with the weighted elements as an imaging result (\tilde{f}).

2. The method as claimed in claim 1, wherein a cross-sectional image (fₒₛ) of the sample is determined based on the multiple digital raw images using a reconstruction method prior to weighting, and the weighting is based on elements of the cross-sectional image (fₒₛ).

3. The method as claimed in claim 2, wherein weighting one of the elements in the intermediate imaging result (fᵣ) includes multiplying the one of the elements by an element of the cross-sectional image (fₒₛ).

4. The method as claimed in claim 1, wherein a joint reconstruction method is used for determining the intermediate imaging result (fᵣ).

5. The method as claim in claim 1, wherein an iterative joint reconstruction method is used as the joint reconstruction method.

6. The method of claim 2, wherein weighting one of the elements in the intermediate imaging result (fᵣ) includes multiplying the one of the element by a factor that depends on at least one of (a) elements of the raw images (gᵢ), (b) the elements of the intermediate imaging result (fᵣ), or (c) the elements of the cross-sectional image (fₒₛ).

7. The method as claimed in claim 6, wherein the factor depends exclusively on at least two of the elements of the raw images (gᵢ).

8. The method as claimed in claim 6, wherein the factor depends exclusively on at least two of the elements of the intermediate imaging result (fᵣ).

9. The method as claimed in claim 6, wherein the factor depends exclusively on at least two of the elements of the intermediate imaging result (fᵣ) and on at least two of the elements of the cross-sectional image (fₒₛ).

10. The method as claimed in claim 1, wherein the raw images (gᵢ) are recorded sequentially by illuminating the sample in different phases with periodically structured illumination light.

11. A microscope, comparing:
a light source configured to generate periodically structured illumination light in different phases for illuminating a sample;
a two-dimensional spatially resolving detector configured to record raw images (gᵢ) of the sample; and
a control unit, comprising a processor and a memory coupled to the processor, and configured to:
determine, using a reconstruction method, an intermediate imaging result (fᵣ) for the sample with an increased resolution using the raw images (gᵢ),
performing weighting on elements of the intermediate imaging result (fᵣ), and
output the intermediate imaging result (fᵣ) with the weighted elements as an imaging result (\tilde{f}).

12. The microscope as claimed in claim 11, wherein no stop that optically sections the sample is arranged in front of the detector.

13. The microscope as claimed in claim 11, wherein the control unit is configured to determine a cross-sectional image (fₒₛ) of the sample based on the raw images using a reconstruction method prior to weighting, and the weighting is based on elements of the cross-sectional image (fₒₛ).

14. The microscope as claimed in claim 13, wherein weighting one of the elements in the intermediate imaging result (fᵣ) includes multiplying the one of the elements by an element of the cross-sectional image (fₒₛ).

15. The microscope as claimed in claim 11, wherein the control unit is configured to determine the intermediate imaging result (fᵣ) using a joint reconstruction method.

16. The microscope of claim 15, wherein weighting one of the elements in the intermediate imaging result (fᵣ) includes multiplying the one of the element by a factor that depends on at least one of (a) elements of the raw images (gᵢ), (b) the elements of the intermediate imaging result (fᵣ), or (c) the elements of the cross-sectional image (fₒₛ).

17. The microscope as claimed in claim 16, wherein the factor depends exclusively on at least two of the elements of the raw images (gᵢ).

18. The microscope as claimed in claim 16, wherein the factor depends exclusively on at least two of the elements of the intermediate imaging result (fᵣ).

19. The microscope as claimed in claim 16, wherein the factor depends exclusively on at least two of the elements of the intermediate imaging result (fᵣ) and on at least two of the elements of the cross-sectional image (fₒₛ).

20. A control unit for use in a microscope, the control unit comprising a processor and a memory coupled to the processor, wherein the processor is configured to:
receive raw images of a sample captured by the microscope based on structured light illumination having different phases,
determine, using a reconstruction method, an intermediate imaging result (fᵣ) for the sample with an increased resolution using the raw images (gᵢ),
perform weighting on elements of the intermediate imaging result (fᵣ), and
output the intermediate imaging result (fᵣ) with the weighted elements as an imaging result (\tilde{f}).

21. The control unit as claimed in claim 20, wherein the processor is configured to determine a cross-sectional image (fₒₛ) of the sample based on the raw images using a reconstruction method prior to weighting, and the weighting is based on elements of the cross-sectional image (fₒₛ).

22. The microscope as claimed in claim 21, wherein weighting one of the elements in the intermediate imaging result (fᵣ) includes multiplying the one of the elements by an element of the cross-sectional image (fₒₛ).
